(19) United States
(12) Patent Application Publication
(10) Pub. No.: US 2024/0116217 A1
(43) Pub. Date: Apr. 11, 2024

(54) Die Plate For Hot Die Face Granulation of Melts and Method for the Production Thereof

(71) Applicant: MAAG Automatik GmbH, Grossotheim (DE)

(72) Inventors: Florian Fischer, Ebersberg (DE); Michael Eloo, Xanten (DE); Stefan Dahleimer, Kleinostheim (DE)

(21) Appl. No.: 17/769,201

(22) PCT Filed: Sep. 30, 2020
(86) PCT No.: PCT/EP2020/077299

§ 371 Date: Apr. 14, 2022

(30) Foreign Application Priority Data
Oct. 15, 2019 (DE) 10 2019 127 666.7

(51) Int. Cl. B29B 9/06; B22F 5/10; B29B 13/02; B29C 33/38; B29C 48/00; B29C 48/05; B29C 48/30; B33Y 80/00

(52) U.S. Cl. CPC B29B 9/065; B22F 5/10; B29B 13/022; B29C 33/3842; B29C 48/0022; B29C 48/05; B29C 48/3001; B33Y 80/00; B22F 2998/10; B29L 2031/757

(57) ABSTRACT

A hot die face granulation of melt-type materials, such as polymer melts, which pass through the melt channels of a die plate and are divided into granulate while still hot on the outlet surface. The die plate includes a die plate body having melt channels, which pass through the die plate body and feed onto an outlet surface distributed in ring-shaped formations, on which outlet surface the exiting melt strands are divided by a rotating blade, a granulation head comprising a die plate of this type, as well as an underwater or water ring granulator comprising a granulation head of this type. The invention also relates to a method for producing a die plate of this type.

The present invention relates generally to the granulation of melt-type materials, such as polymer melts, which pass through the melt channels of a die plate and are hot discharged on the outlet surface and divided into granulate. On the one hand, the invention relates to a die plate with a die plate body comprising melt channels, which pass through the die plate body and feed onto an outlet surface distributed in ring-shaped formation, on which outlet surface the exiting melt strands are hot-cut by a rotating blade, a granulation head with a die plate of this kind as well as a granulator, in particular an underwater, water ring or air granulator with a hot die face granulation head of this type. On the other hand, the invention relates to a method for producing a die plate of this type.

Die plates of this type can cooperate with a cutter head of the granulator, the rotating blades of which scrape along the outlet surface of the die plate in order to hot-cut the melt strands exiting from the melt channels, wherein the outlet surface around the mouths of the melt channels forms an engagement or counter surface for the rotating blades, which can often be flat, but also spherical or concave or curved, in order to support a blade edge moving along in a flat or linear manner, depending on the blade contouring.

In the case of underwater granulators, said blades rotate in a water bath so that the cut pellets do not adhere to one another and solidify or cool down to the point at which they are easier to handle.

In the case of water ring granulators, the blades and die plate face are not positioned in a water bath, but are circumferentially enclosed by an annular stream of water flowing past, which entrains and carries away the cut pellets, cooling them to initiate solidification. The rotating blades cut off the melt strands exiting the face of the die plate in an intrinsically dry state and discharge the still hot, melt-type granulate into the rotating water ring. The “water ring” does not necessarily have to consist of water, which can nonetheless also happen, but can also comprise another transport and/or cooling medium, e.g. in the form of a liquid mixture of substances, or at least partially also in the form of a droplet and/or spray mist stream or a mixture thereof. In the case of said underwater granulators, too, the water bath or the water flow past the die plate and the blades does not necessarily have to consist of water, which may nonetheless happen, but another transport and/or cooling medium can also be used in an analogous manner.

In the case of air or cooling air granulators, the hot die face is dry, wherein a rotating blade can also move along a die plate in order to cut off the melt strands exiting from the channel mouths. The hot cut-off granulate is further conveyed and cooled by a stream of air, which will take more time due to the lower thermal conductivity of air compared to water.

In said cases, especially in underwater granulation and water ring granulation, but to a certain extent also in said air granulation, the die plates are subject not only to the mechanical stress caused by the passing blades, but also to complex thermal requirements resulting from the hot die face. On the one hand, the melts or melt strands should flow through and out of the die plate within a certain temperature range in order to prevent freezing of the melt channels and, at the same time, to maintain temperature limits of the material to be granulated. As a result, the die plate should have a given temperature, which is often relatively high. On the other hand, the environment of the die plate in the form of the water bath or water ring is quite cold, so that very high temperature gradients occur at the die plates.

In order to prevent excessive cooling of the die plates from their outlet surface, especially when they are used in underwater granulators and are surrounded by a water bath and are in contact with the cold process water, such die plates are sometimes thermally insulated or provided with insulation. Such insulation can, for example, comprise a hollow chamber inside the die plate body, which can be formed over as large an area as possible in order to avoid direct heat transfer from the hot inlet side to the cold outlet side of the die plate via the thermally highly conductive, usually metallic material of the die plate body.

Alternatively or in addition to such a hollow chamber filled with air or gas or also vacuumed, it is also known to heat the die plate from the inside, wherein a heating fluid is circulated through said hollow chamber or separate heating channels.

Even though cooling by the passing water ring and freezing of the melt channels or channel mouths is relatively minor problem in water ring granulators, exact temperature control for the material to be granulated must also be maintained in water ring granulators. In principle, this also applies in a similar way to air granulators. Water ring granulators and also air granulators are not only used for granulating thermoplastics, but are also popular for granulating pharmaceuticals or foodstuffs, which are usually sensitive to incorrect temperatures during granulating and require a very narrow temperature range, so that the die plate must be heated and/or cooled or insulated sensitively.

Die plates for underwater granulation are known, for example, from US 2006/0165834 A1, US 2007/0254059 A1, WO 2010/019667 A1 or DE 40 36 196 A1.

In this context, the latter document WO 2010/019667 A1 proposes to insulate the melt channels and the wear ring, on which the melt channels open, from the rest of the die plate body by means of inserts made of less conductive material. DE 40 36 196 A1 suggests providing heating medium channels between the melt channels in the die plate and forming additional insulating channels in the die plate body between these heating medium channels and the plate face cooled by the water bath, which forms the die plate outlet surface where the melt channels open out, through which an inert gas flows as an insulating medium.

Die plates for water ring granulation are known, for example, from AT 508 199 B1 or DE 10 2012 012 070 A1.

Die plates for air or cooling air granulation are known, for example, from EP 26 99 235 B1.

Due to the various insulation and temperature control measures, such die plates have an increasingly complex geometry, which entails a corresponding manufacturing effort. Especially the hollow chambers in the die plates are difficult to manufacture.

In addition, such die plates need sufficient stability to withstand external forces and thermal stresses. In addition to the stress caused by the rotating blades, the die plate must also withstand the water pressure exerted on the outlet surface by the process water in the underwater box. In addition, thermal stresses occur due to the strong temperature gradient in the die plate. In this respect, it can be seen that for insulation purposes or for the temperature control, the die plate is hollowed out over a large area and the walls bounding the temperature control cavity on the inlet and outlet surfaces of the die plate are often only very thin, so that even the limited water pressure can lead to deformations. At the same time, the die plate must remain permanently tight and free of cracks to prevent the ingress of process water.

It is the underlying object of the invention to provide an improved die plate, an improved granulation head with a die plate of this type, an improved granulator as well as an improved method for the production of a die plate of this type, that avoid disadvantages of the prior art and advantageously further develop the latter. In particular, the aim is to achieve improved adaptation of the die plate structure to the thermal requirements and operating conditions without impairing mechanical stability.

According to the invention, said task is solved by a die plate as claimed in claim 1, a granulation head with such a die plate as claimed in claim 18, a granulator as claimed in claim 20, and a method for producing a die plate as claimed in claim 23. Preferred embodiments of the invention are the subject-matter of the dependent claims.

It is therefore proposed not to assemble the die plate body from various inserts and cover parts, but to build it up layer by layer by additive material application in the required contouring, including the at least one hollow chamber, thereby eliminating the geometrical limitations of conventional die plates as they are given by machining and soldering of plate parts. According to the invention, the die plate body, including its at least one temperature control and/or insulating hollow chamber and the body sections surrounding the melt channels, is formed by additive material application as an integral single-piece layered body whose material layers are individually consolidated layer by layer. The additive material application and the resulting layer-by-layer contour make it possible to achieve complex, harmonious and organically grown wall contours in the area of the hollow chamber formed for temperature control or thermal insulation, which provide the die plate with stability and prevent cracking, as well as providing favorable flow conditions for a temperature control or insulating medium flowing through the hollow chamber. At the same time, the integral single-piece layered structure allows a dense design to be achieved despite the hollow chamber and melt channels.

In particular, the layered die plate body may be formed from a metallic material. Regardless thereof, the layered die plate body can be built up from layers in a 3D printing process using a 3D printing head, a stereolithography process or another additive build-up process.

In particular, material layers can be successively liquefied and/or solidified layer by layer by means of an energy beam. For example, one or more materials can be applied in layers in pulverulent and/or paste-like and/or liquid form and melted or solidified and/or cured and/or chemically reacted by a laser beam or electron beam or plasma beam to form a cured layer. Due to the layered formation, the die plate body can also be precisely form-fitted in the area of the temperature control and/or insulating hollow space or other sections that are difficult to form, such as the melt channel walls or heating fluid connections or channels with changing curvatures and/or angular or rounded transitions between different contour sections, even with small-particle surface contours.

The melt channels may be formed in channel columns which are at least partially free-standing in the hollow chamber of the die plate body and integrally formed in a single piece, materially homogeneous with walls of the die plate body bounding said hollow chamber on opposite sides. Said channel columns, through which the melt channels extend, can thereby grow organically out of the inlet- and outlet-surface body walls that delimit the hollow space lying between them, which not only results in a stable structure but also avoids leakage problems at the outlet points of the melt channels.

Said channel columns, together with other contour sections of the die plate body, can be built up in layers in parallel or successive work steps in said manner, in particular printed using the 3D printing process. Said channel columns can first be formed as a solid material body, into which the respective melt channel is then machined in a subsequent machining step. Alternatively, the channel columns can also already be provided with a blind hole or a through hole in the layered structure, which blind hole or through hole can then be machined in a subsequent processing step, for example drilled out and/or polished and/or ground. Advantageously, the melt channels have as smooth a wall surface as possible with a low roughness depth in order to impair the melt flow as little as possible. While the outer walls of said channel columns can remain unmachined or have a layered body surface, the melt channel wall is advantageously machined, in particular drilled and/or milled and/or polished and/or ground and/or honed.

In order to reduce stress peaks in the root region of the channel columns or even to prevent cracking in the transition region towards the body walls on the inlet and outlet side, said channel columns can preferably have harmonically widening end sections and/or, viewed in cross-section, have rounded outer circumferential contours in the transition region to the adjacent die plate walls. In particular, the channel columns can be undercut on their outer walls in both axial directions that are parallel to the melt flow. Due to the layered structure, however, the usual problem of demolding does not arise with such undercut contours.

In order to achieve sufficient stability of the end walls of the die plate bounding the hollow chamber even in the case of large-area expansion of the hollow chamber, in further development of the invention support walls or pillars can be provided inside the hollow chamber, which connect the inlet-side body wall to the outlet-side body wall and support them against each other.

In a further embodiment of the invention, said support walls and/or pillars are also of layered construction or are formed as a layered body and/or are integrally molded in one piece to the body walls which bound said hollow chamber on opposite sides, in particular the inlet and outlet sides of the die plate. By integrally molding the support walls and/or pillars to the end walls of the die plate, there can be achieved even greater stability. At the same time, the additive, layer-by-layer design allows a very slim contouring of the support walls or pillars, which avoids unwanted heat transfer.

Advantageously, there may be provided a plurality of support walls and/or pillars distributed throughout the hollow space to provide uniform support and/or also to provide distribution of the temperature control fluid when a temperature control fluid is flowing through the hollow chamber. Advantageously, for example, more than ten or more than 20 or more than 30 support walls and/or pillars may be provided in said hollow chamber.

Said support walls and/or pillars may have a wall or pillar thickness or diameter that may be less than 40% or less than 30% or less than 20% of the height of the respective support wall or pillar.

In further embodiments of the invention, the support walls and/or pillars may form a support structure that is formed approximately uniformly distributed throughout the hollow chamber and/or forms a uniform support pattern.

In further embodiments of the invention, the support walls and/or the support pillars may form an undulating pattern and/or have an undulating course when a cross-sectional plane perpendicular to the main melt flow direction is viewed and/or when the end wall of the die plate is cut away, the exposed hollow chamber is viewed in a viewing direction approximately parallel to the melt flow direction.

The support walls and/or pillars may extend along parallel wavy lines from one side of the die plate to an opposite side of the die plate, particularly from the side where the die plate has a temperature control center inlet to an opposite die plate side where a temperature control center outlet is provided. Accordingly, the temperature control fluid introduced into the hollow chamber can flow uniformly through the die plate despite the large number of support walls and/or pillars. With an undulating course of the support walls, the temperature control effect of the fluid flowing through can be increased even further.

In further development of the invention, said support walls may have apertures whose edge contour may be rounded and/or arcuate, at least in sections. In particular, arch-shaped apertures may be provided in a support wall in a row such that a respective support wall has a row of window-shaped or arch-shaped apertures. The rounded edge contour allows stress peaks to be avoided and uniform introduction of forces to be achieved.

In an advantageous further embodiment of the invention, said hollow chamber may extend at least in an inner region of the die plate enclosed by the annular pattern of melt channels and/or at least in an outer region of the die plate surrounding the annular pattern of melt channels. Advantageously, the hollow chamber extends both on the outside and on the inside of said melt channels so that, on the one hand, both adjacent neighboring areas of the annular melt channel pattern are thermally insulated and/or can be temperature controlled. In particular, the hollow chamber extends from the inside to the outside beyond the melt channels or channel columns in which the melt channels are formed, so that said melt channels are free-standing in the hollow chamber.

The hollow chamber may extend over at least 30% or even more than 50% or more than 60% or more than 70% of the cross-sectional area of the die plate to provide the best possible insulation and/or temperature control. Regardless thereof, the hollow chamber may have a height in the axial direction, i.e. in the direction of the blade rotation matter or in the direction of the melt flow, which is at least 25% or even more than 33% or even more than 50% of the height or thickness of the die plate.

In order to get the raw material powder or raw material that has not solidified during additive manufacturing of the die plate out of the forming hollow chamber again, the die plate can have at least one discharge holes, preferably several discharge holes arranged in a distributed manner, which lead out of said hollow chamber and open on an outer side of the die plate, preferably on one of the opposite end faces of the die plate. Advantageously, said discharge holes can open on the inlet side of the die plate with which the die plate is placed on the connection body of the granulation head, so that the discharge holes are covered or closed when the granulation head is assembled.

To prevent premature wear of the die plate, a wear-resistant hard material ring can be placed on the outlet side of the die plate, along the outside of which the blades of the cutter head run to cut off the existing melt strands. Said outer surface of the wear-resistant hard material ring forms a blade sliding surface cooperating with the blades, on which the rotating blades can slide along and against which the blades can be pressed.

Said wear-resistant hard material ring can be manufactured separately from the layered body of the die plate and can be attached to the die plate body, which is formed as a layered body, in various ways, for example by being brazed or soldered on.

In an alternative further development of the invention, however, the layered die plate body can also be materially bonded to the hard material ring and/or built up on said hard material ring during layered construction. The hard material ring can serve as the base body on which the die plate body is then built up layer by layer, with the lowest layer or layer of the layered body directly adjacent to the hard material ring being joined to the hard material ring by material bonding and/or microforming and/or chemical bonding. When the powder layer or raw material layer directly on the hard material ring is melted and solidified, the solidifying layer material interlocks in the micropores of the hard material and covers it firmly. This not only saves a subsequent joining step, such as said soldering, but also achieves a tight connection between the hard material ring and the adjacent die plate body.

The hard material ring can be single-layered or not built up in 3D printing.

On the other hand, however, the die plate body, which is configured as a laminated body, can also be built up from the opposite side, i.e. the inlet side, wherein, in advantageous further development of the invention, the laminated body can be built up directly on the adjoining connecting piece of the granulation head. Said fitting may have a distribution chamber and/or distribution channels to distribute the molten material coming from a melt source, such as an extruder, to the melt channels of the die plate.

The die plate body built up in the additive process, layer by layer, can thereby be connected to the said connection body of the granulation head in the said manner by material bonding and/or by microform bonding, for example by melting and solidifying the powder layer resting on the connecting piece, so that a material bonding and/or microform bonding and/or a chemical bonding results in the said manner.

As an alternative to such shaping of the die plate body during additive assembly of the die plate body, the latter can also be connected to the granulation head in another way, for example screwed and/or soldered thereto and/or fastened in another way.

The invention is explained in more detail below on the basis of a preferred exemplary embodiment and the corresponding drawings. The drawings show:

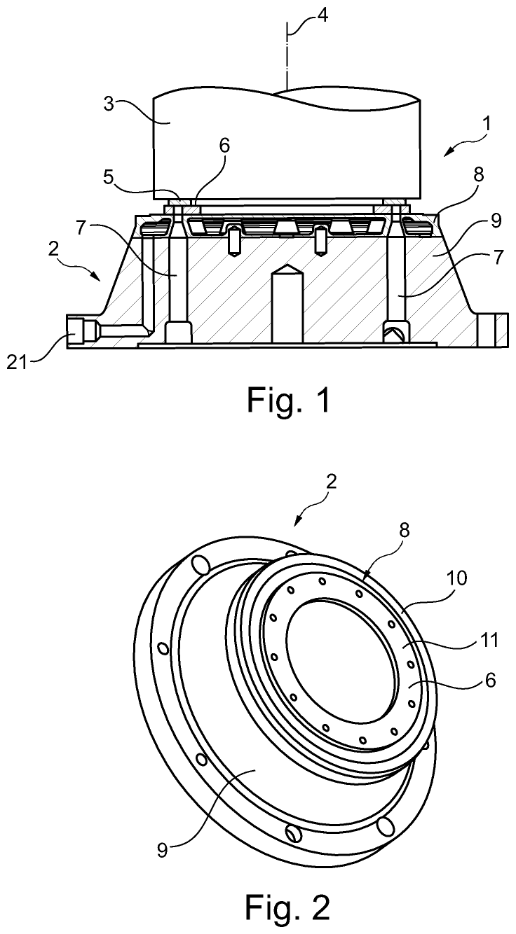

FIG. 1: is a schematic, partially cutaway view of the granulation head and the blade head of a hot die face granulator, e.g. underwater granulator, showing the additively manufactured die plate placed on the connection body of the granulation head and the blades of the blade head moving over it;

FIG. 2: is a perspective view of the hot die face granulation head of FIG. 1, showing the die plate and its hard material ring onto which the melt channels open;

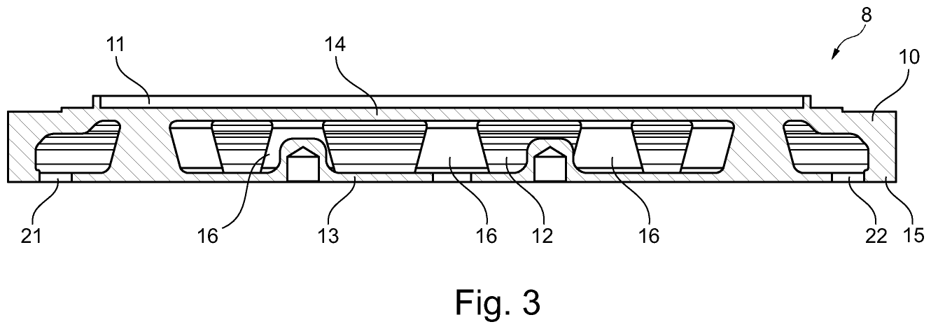

FIG. 3: is a sectional view through the die plate from the preceding figures, showing the hollow chamber inside the die plate and the channel columns through which the melt channels extend;

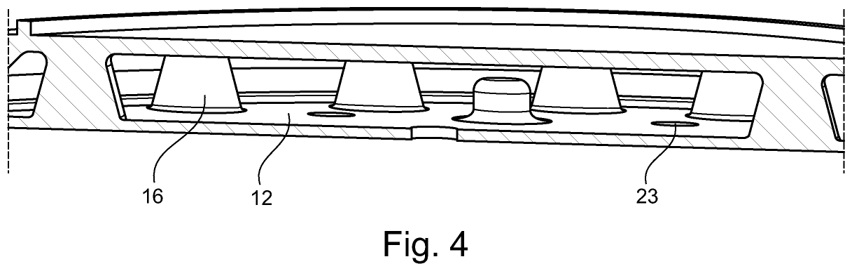

FIG. 4: is a sectional, oblique perspective view of the die plate, illustrating the contouring of the channel columns;

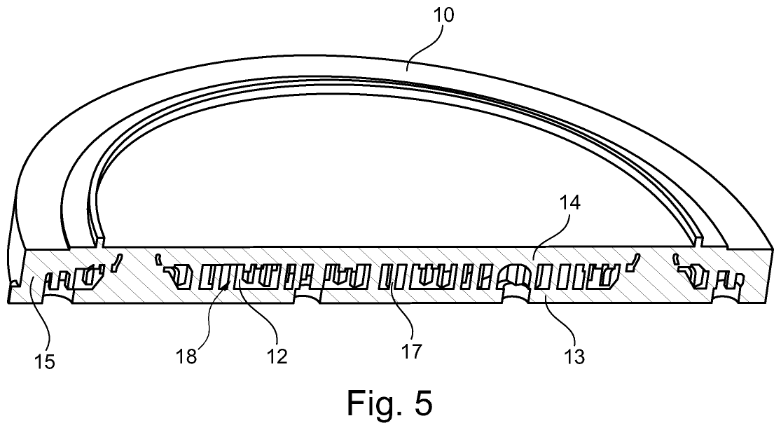

FIG. 5: is a perspective sectional view of the die plate showing the die plate body without hard material ring and with melt channels not yet drilled out, wherein in the hollow chamber of the die plate the support wall and/or pillar structure is shown according to an advantageous embodiment of the invention;

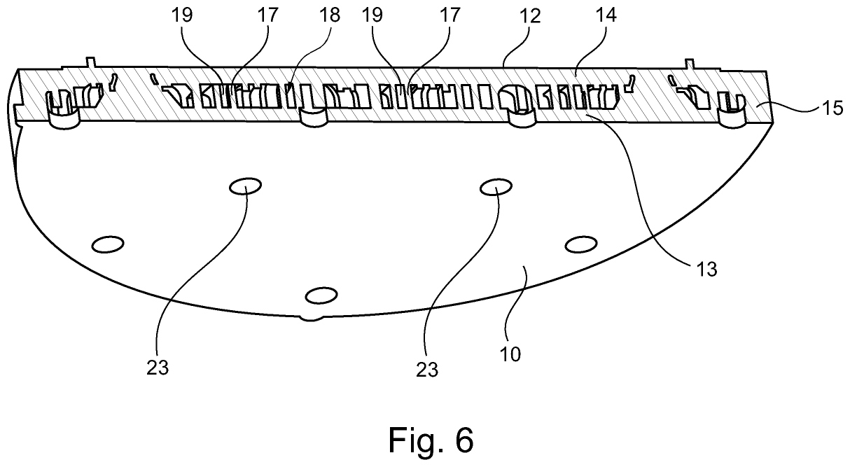

FIG. 6: is a perspective, cutaway oblique view of the die plate similar to FIG. 5, showing its inlet side and illustrating the arch-shaped apertures through the support walls;

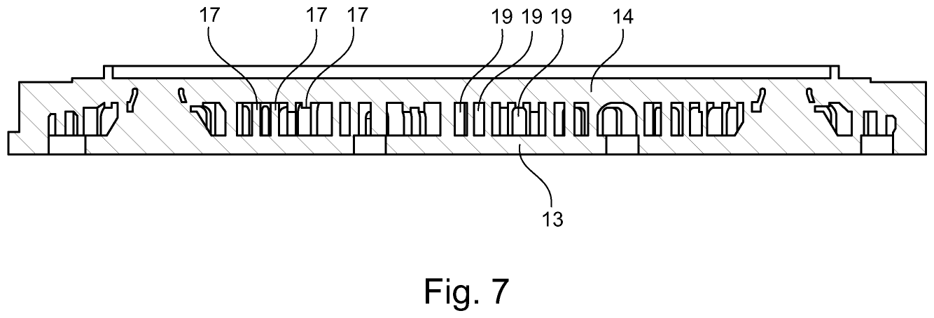

FIG. 7: is a sectional view of the die plate of FIGS. 5 and 6; and

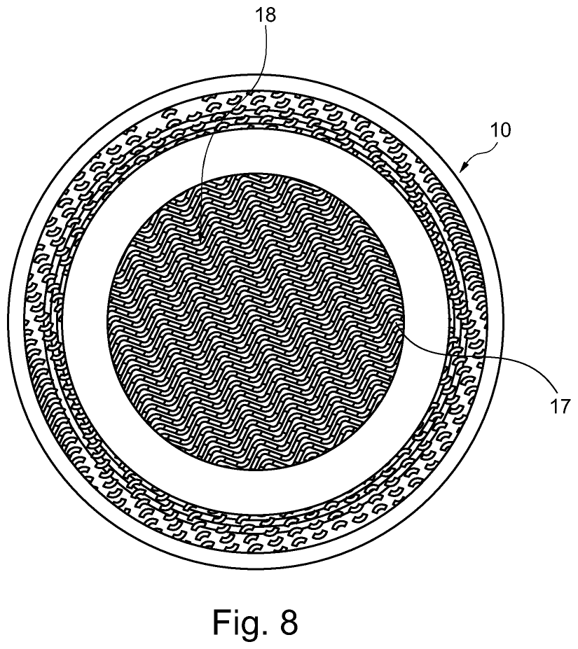

FIG. 8: is a top view of the die plate from the preceding figures showing a cutaway top view of the support wall structure in the hollow chamber of the die plate, showing its undulating support wall course.

As FIG. 1 shows, the hot die face granulator 1 comprises a granulation head 2, which can be arranged in a fixed position, and a cutter head 3, which can be driven in rotation about a cutter head axis 4 and can be pressed against the granulation head 2 in the direction of the cutter head axis 4 and/or can be closed and/or preloaded, so that blades 5 provided on the end face of the cutter head 3 can slide along a blade sliding surface 6 of the granulation head 2.

Melt channels 7, which are distributed in an annular pattern, open onto the said blade sliding surface 6. These channels pass through the granulation head 2 and can be fed with melt from an inlet side of the granulation head 2, for example by an extruder which kneads the melt and conveys it under pressure to the granulation head 2. The melt channels 7, which are distributed in an annular pattern, can communicate on the inlet side with a distribution chamber that is supplied with pressurized melt in said manner.

The melt channels 7 can be arranged on a common pitch circle, but if necessary they can also be arranged offset inwardly and/or outwardly relative to such a pitch circle, and two or more rows of melt channels can also be provided distributed in an annular pattern.

As FIG. 1 shows, the granulation head 2 comprises a die plate 8, which is seated with its inlet-side end face on a connecting body 9 of the granulation head 2. Said annular pattern of melt channels 7 extends through the die plate body 10 of die plate 8 and communicates with correspondingly arranged melt channels in said connector body 9.

On the outlet side of the die plate body 10 sits a wear-resistant hard material ring 11, through which said melt channels 7 continue and on the outside of which said melt channels 7 open. Said outer surface of the hard material ring 11 forms the blade sliding surface 6 on which the blades 5 of the blade head 3 slide along in order to cut off the existing melt strands.

As shown in the figures, said blade sliding surface 6 and/or the exit face of the die plate 8 may be substantially flat and/or extend substantially perpendicular or transverse to the blade head axis 4 about which the blade head 3 rotates. Alternatively, the outlet side of the die plate 8 and/or at least the blade slide surface 6, on which the melt channels 7 open, can also be contoured in a curved or conical manner or at an angle to the blade head axis 4, for example in the form of a spherical spherical cap or a truncated cone or another annular torus contour, wherein in such a case the melt channels 7 can advantageously be set at an angle to the blade head axis 4 and/or open perpendicularly onto the obliquely set blade slide surface 6.

Regardless thereof, the inlet side face of the die plate 8 can also have a curvature or be conically contoured or otherwise concave or convex. In the case of the essentially flat design of the inlet side shown in FIG. 1, the latter can be placed on an end face of the connecting body 9 which is also flat.

In the case of underwater granulation, said blades 5 rotate in a water bath in a cutting chamber surrounding the blade head 3 and abutting the die plate exit surface so that the existing melt strands are cut off in the water bath, see WO 2010/019667A1. In the case of water ring granulators, the blades and die plate face are not positioned in a water bath, but are circumferentially enclosed by an annular stream of water flowing past, which entrains and carries away the cut pellets, cooling them to initiate solidification. The rotating blades cut off the melt strands exiting the face of the die plate in an intrinsically dry state and discharge the still hot, melt-type granulates into the rotating water ring, cf. AT 508 199 B1.

As the figures show, the die plate 8 has a hollow chamber 12 in its interior, which is configured for thermal insulation and/or temperature control, e.g. heating or cooling, of the die plate 8 and is bounded towards the inlet and outlet end faces of the die plate 8 by two body walls 13 and 14. Towards the outer circumference, said hollow chamber 12 is closed off by a circumferential wall 15, which is connected circumferentially to the two end body walls 13 and 14, in particular is formed in a single piece with homogeneous material. In particular, the hollow chamber 12 can be provided to control temperature of the melt channels 7, for example to heat them by a heating medium flowing through the hollow chamber 12, and/or to thermally insulate them from the outlet end face of the die plate 8.

As shown in the figures, said tempering and/or insulating hollow chamber 12 may extend over substantially the entire cross-sectional area of the die plate 8, in particular filling the inner region within the annular melt channel pattern and/or filling a region surrounding said annular pattern of melt channels on the outside. In particular, the hollow chamber 12 may extend from the inside to the outside across the melt channels 7 so that the melt channels 7 or channel columns 16 through which the melt channels 7 extend are free-standing in the hollow chamber 12 and penetrate the hollow chamber 12.

Said die plate body 10, including its end body walls 13 and 14 and peripheral wall 15, which together define the hollow chamber 12, and said channel columns 16, is formed as a layered structural body whose layers are consolidated in layers. In particular, said layered body may be produced by a 3D printing process, wherein said body and peripheral walls 13, 14, 15 and channel columns 16 may be integrally connected to each other in one piece, homogeneously in terms of material, and each may be built up in layers.

As FIGS. 3 to 6 show, the channel columns 16 can initially be built up layer by layer as solid columns. The melt channels 7 can subsequently be machined into said channel columns 16 so that the melt channels 7 can extend from the entry side of the die plate 8 through the latter to its exit side in the manner of through-holes with a change in cross-section, if desired.

As shown in the figures, said channel columns 16 may advantageously be conically contoured overall or have a conically contoured outer surface which may, for example, taper from the inlet side to the outlet side.

Regardless of such conical contouring, end portions of the channel columns 16 may widen toward the adjacent body walls 13 and 14 and/or have a rounded contour, so that the channel columns 16 may have a harmonious thickening or widening at the ends and may have a smooth, rounded transition toward the body walls 14 and 15.

In order to support the relatively thin frontal body walls 13 and 14, support walls 17 and/or pillars may be provided in said hollow chamber 12, which may form an overall honeycomb-like support structure 18 connecting or supporting the opposite body walls 13 and 14 against each other.

Said support structure 18 may be integrally connected in one piece to one or both of the opposing body walls 13 and 14, and may in particular be integrally formed thereon by layered construction. Regardless thereof, said support structure 18 can be formed in layers as a layered body, in particular produced by a 3D printing process. Advantageously, said support structure 18 can be produced in parallel with the layer-by-layer construction of the body and/or peripheral walls 13, 14, 15 or the channel columns 16 in the 3D printing process.

Said support walls 17 may be characterized by a slender wall thickness, for example, providing a wall thickness to wall height ratio of 1:5 or 1:7 or smaller.

As FIG. 9 shows, the support walls 17 can have an undulating contour when the walls are viewed in a viewing direction parallel to the blade head axis. The waveform can follow an essentially straight wave direction, but an arcuate wave direction can also be provided if necessary. In particular, the corrugated support walls 17 may extend from one die plate side toward an opposite die plate side.

Regardless thereof, the support walls 17 may have a substantially parallel course to each other and/or be formed with a substantially constant gap dimension between them.

Advantageously, more than ten or more than 20 support walls 17 can be provided, in particular arranged in a parallel course to each other.

As shown in the figures, said support walls 17 may each be provided with preferably window or door arch shaped apertures 19 through which adjacent channels between adjacent support walls are interconnected. When a temperature control fluid flows through the support structure 18, the temperature control fluid can flow through the apertures transversely to the course of the support wall and distribute itself evenly over the hollow chamber.

The apertures 19 specified in the support walls 17 can advantageously be rounded in an arcuate manner at least in sections, in particular be rounded in an arcuate manner towards at least one body wall 14 or have a rounding 20. The support walls 17 may form archways around the apertures 19.

As FIG. 3 shows, the die plate 8 can have inlet and outlet ports 21 and 22 through which a temperature control medium, for example oil or water or a mixture for temperature control of the die plate, can be introduced into it or discharged or circulated through it. In particular, the temperature control medium can be circulated through at least part of the hollow chamber 12, wherein the support walls 17 can effect a distribution of the temperature control medium.

As shown in FIGS. 4 and 6, the die plate 8 may further have discharge holes 23 that may connect the hollow chamber 12 to the exterior. Said discharge holes 22 allow unsolidified powder from the 3D printing process to be removed from the hollow chamber 12.

Advantageously, the discharge openings 23 may open onto the inlet face of the die plate 8 to be concealed when attached to the connecting body 9 of the granulation head 2.

Advantageously, the die plate body 10 can be built up on the connection body 9 of the granulation head 2 so that the die plate body 10 is attached to the connection body 9 by material bonding and/or by microform bonding and/or by chemical bonding. In particular, the connection body 9 can serve as a base body in the 3D printing process, on which the material powder or raw material is poured or applied, and then liquefied and solidified layer by layer. The layer located directly on the connection body 9 is thereby firmly bonded to the connection body 9.

Conversely, however, the die plate body 10 can also be attached to the wear-resistant hard material ring 11 in a corresponding manner, in which case said hard material ring can serve as the base body in the 3D printing process.

Alternatively, however, the die plate body 10 can also be connected to the connection body 9 and/or the hard material ring 11 in a conventional manner, for example by soldering and/or screwing and/or pressing tight.

The hard material ring 11 can be a single piece, but may also be composed of different ring segments. The same applies to the connection body 9 and, if necessary, also to the layered die plate body 10, which can be composed, for example, of two halves or of four cake pieces or in some other way segment-wise. Advantageously, however, the die plate body 10 does not have an interface or parting line that would pass through a melt channel.

1. A die plate comprising:
a die plate body having melt channels which pass through the die plate body and feed onto an outlet surface distributed in a ring-shaped formation, and at least one hollow chamber, wherein the die plate body is configured as a layered structural body whose material layers are individually consolidated layer by layer.

2. The die plate according to claim 1, wherein the die plate is configured for hot die granulation of melts;
wherein the outlet surface is configured for receiving exiting melt strands from the melt channels and presenting them for hot-cut by a rotating blade;
wherein the melt channels are distributed in an annular melt channel pattern; and
wherein the at least one hollow chamber is configured for:
controlling the temperature of the die plate; and/or
thermally insulating the melt channels at least partially within the annular melt channel pattern.

3. The die plate according to claim 2, wherein the melt channels are formed in channel columns that are arranged at least partially free-standing in the hollow chamber and are integrally connected in a single piece, material-homogeneously, to body walls of the die plate body that delimit the hollow chamber on opposite sides; and
wherein the channel columns are formed as a layered structural body, the material layers of which are individually consolidated layer by layer.

4. The die plate according to claim 3, wherein the channel columns widen towards opposite end portions and/or have a widening rounding at opposite end portions which forms a harmonious transition to the respective adjacent body wall of the die plate body.

5. The die plate according to claim 4, wherein an outer wall of the channel columns is undercut in both axial directions parallel to a melt flow direction.

6. The die plate according to claim 5, wherein a support structure is formed in the hollow chamber to support opposite body walls of the die plate body bounding the hollow chamber against each other.

7. The die plate according to claim 6, wherein the support structure forms a wave pattern running along a wave running direction from one die plate peripheral side to an opposite die plate peripheral side.

8. The die plate according to claim 6, wherein the support structure comprises support walls and/or pillars integrally connected to and/or formed integrally with the opposing body walls of the die plate body in a materially homogeneous manner.

9. The die plate according to claim 8, wherein the support walls and/or pillars are constructed as a layered structural body and are consolidated layer by layer.

10. The die plate according to claim 9, wherein more than 15 support walls are provided in the hollow chamber.

11. The die plate according to claim 9, wherein the support walls and/or pillars are arranged along mutually parallel lines.

12. The die plate according to claim 11, wherein the support walls and/or pillars are provided with arch-shaped or window-shaped apertures; and
wherein the apertures are rounded at least towards one body wall of the die plate body bounding the hollow chamber.

13. The die plate according to claim 8, wherein the support walls and/or pillars have a wall thickness/height ratio of 1:5 or smaller.

14. The die plate according to claim 2, wherein the die plate body further has at least one discharge hole for removing unconsolidated raw material from the hollow chamber.

15. The die plate according to claim 14, wherein the at least one discharge hole opens onto an inlet-side end face of the die plate.

16. The die plate according to claim 2 further comprising a wear-resistant hard material ring, which forms a counter surface for the rotating blade;
wherein the hard material ring is seated on an outlet side of the die plate body; and
wherein the melt channels open out on an outer side of the hard material ring.

17. The die plate according to claim 16, wherein the die plate body is bonded to the hard material ring by a bonding selected from the group consisting of a material bonding, a microform bonding, and a chemical bonding upon solidification of a molten material layer of the layered die plate body adjacent to the hard material ring.

18. A hot die face granulation head having a connection body on which the die plate according to claim 2 is mounted.

19. The hot die face granulation head according to claim 18, wherein the die plate is connected by a bonding selected from the group consisting of a material bonding, a microform bonding, and a chemical bonding during solidification of a molten material layer of the layered die plate body adjacent to the connection support.

20. A hot die face granulator comprising the granulation head according to claim 18.

21. The hot die face granulator according to claim 20, wherein the granulator is configured as an underwater or water ring granulator.

22. The hot die face granulator according to claim 20, wherein the granulator is an air granulator.

23. A method for producing a die plate comprising:
forming, layer by layer by additive material application, a die plate for hot die granulation of melts comprising a die plate body having melt channels that pass through the die plate body and feed onto an outlet surface distributed in ring-shaped formation, on which outlet surface exiting melt strands are hot-cut by a rotating blade, the die plate body having at least one hollow chamber for controlling the temperature of the die plate and/or thermally insulating the melt channels at least partially within an annular melt channel pattern, wherein the die plate body is configured as a layered structural body whose material layers are individually consolidated layer by layer.

24. The method according to claim 23, wherein the die plate body is formed by means of a 3D printing head in a 3D printing process.
